(19) United States
(12) Patent Application Publication
(10) Pub. No.: US 2019/0212153 A1
(43) Pub. Date: Jul. 11, 2019

(54) VEHICLE POSITION ESTIMATE USING INFORMATION FROM INFRASTRUCTURE

(71) Applicant: Continental Automotive Systems, Inc., Auburn Hills, MI (US)

(72) Inventors: Ganesh Adireddy, Bloomfield Hills, MI (US); Bastian Zydek, Auburn Hills, MI (US)

(73) Assignee: Continental Automotive Systems, Inc., Auburn Hills, MI (US)

(21) Appl. No.: 16/244,853

(22) Filed: Jan. 10, 2019

Related U.S. Application Data
(60) Provisional application No. 62/616,179, filed on Jan. 11, 2018.

(51) Int. Cl. G01C 21/32; G08G 1/01; G08G 1/017; G01S 5/00

(52) U.S. Cl. CPC G01C 21/32; G08G 1/0112; G01S 5/0036; G08G 1/017; G01S 5/0054; G08G 1/0141

(57) ABSTRACT

A method of operating a traffic monitoring system comprises receiving sensor data from one or more sensors in communication with a hardware processor, identifying one or more traffic participants from the sensor data, determining one or more attributes associated with each one of the one or more traffic participants, generating a sensor list of the one or more traffic participants, where the sensor list includes identifiers and attributes associated with each of the one or more traffic participants, receiving an object list from the one or more traffic participants, where the object list includes identifiers and attributes for the associated one or more traffic participants. The traffic monitoring system also includes comparing the sensor list with the object list, generating a map from the comparison, generating an updated object list from the comparison and the map, and broadcasting the updated object list.

### CROSS REFERENCE TO RELATED APPLICATIONS

This U.S. patent application claims the benefit of U.S. provisional patent application No. 62/616,179, filed Jan. 11, 2018 which is hereby incorporated by reference.

### FIELD OF THE INVENTION

The invention relates generally to a system for detecting the precise location of one or more vehicles in a controlled environment, using a combination of GPS coordinates and sensors which are part of a localized infrastructure.

### BACKGROUND OF THE INVENTION

Currently, there are many types of systems in place, which are part of a vehicle and local infrastructure, used to map the surrounding environment. There are certain environments where many vehicles and pedestrians may use the same paths, such as golf courses, amusement parks, assisted living communities, and the like. There are situations which occur in these environments where vehicles such as a golf cart, or a shuttle, may be used to transport people through an area also being traversed by pedestrians. This results in the vehicles and pedestrians being very close to one another. For vehicles equipped with automated driving, typical GPS devices (having accuracy approximately or greater than four meters) are not accurate enough to detect when various pedestrians or other objects are in close proximity to the vehicle. Also, GPS signal reception may be poor in an urban canyon environment, or in tunnels.

Further, pedestrians and cyclists often use smart devices which rely on GPS to provide directions and/or tracking information (distance traveled, etc). When in urban locations these signals often have interference from buildings and other users in the same vicinity, making accurate information difficult to obtain.

Accordingly, there exists a need for a system, which may be used to map a local environment with increased accuracy.

### SUMMARY OF THE INVENTION

In one embodiment, a method of operating a traffic monitoring system comprises: receiving, at a hardware processor, sensor data from one or more sensors in communication with the hardware processor and positioned such that the surface area is within a field of view of the one or more sensors. The traffic monitoring system also includes identifying, at the hardware processor, one or more traffic participants from the sensor data. The traffic monitoring system also includes determining, at the hardware processor, one or more attributes associated with each one of the one or more traffic participants. The traffic monitoring system also includes generating a sensor list of the one or more traffic participants, where the sensor list includes identifiers and attributes associated with each of the one or more traffic participants. The traffic monitoring system also includes receiving at the hardware process, an object list from the one or more traffic participants, where the object list includes identifiers and attributes for the associated one or more traffic participants. The traffic monitoring system also includes comparing the sensor list with the object list. The traffic monitoring system also includes generating a map from the comparison of the sensor list with the object list. The traffic monitoring system also includes generating an updated object list from the comparison and the map. The traffic monitoring system also includes broadcasting the updated object list. The present invention also includes a first object detection list which has information related to the location information of each of the vehicles, and a second object detection list which has information related to objects detected in the detection area. The first object detection list is compared to the second object detection list to determine the location of each of the plurality of vehicles.

Another general aspect of the invention includes a traffic monitoring system including: a plurality of sensors connected to at least one infrastructure component, where the plurality of sensors are each operable for detecting one or more objects in a detection area, where a sensor list is generated for each of the objects. The traffic monitoring system also includes at least one communication device associated with the at least one infrastructure component. The traffic monitoring system also includes a hardware processor operable to receive a communication from the at least one communication device and each of a plurality of traffic participants, where each communication from the plurality of traffic participants includes an object list; and a hardware memory in communication with the hardware processor, the hardware memory storing instructions that when executed on the hardware processor cause the hardware processor to perform operations including: The traffic monitoring system also includes comparing the sensor list with the object list. The traffic monitoring system also includes generating a map from the comparison of the sensor list with the object list. The traffic monitoring system also includes generating an updated object list from the comparison and the map. The traffic monitoring system also includes broadcasting the updated object list.

Other embodiments of these aspects include corresponding computer systems, apparatus, and computer programs recorded on one or more computer storage devices, each configured to perform the actions of the methods.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic view of an exemplary overview of a vehicle-traffic system;

FIG. 2 is a diagram of an intersection incorporating an object detection system, according to embodiments of the present invention;

FIG. 3 is another diagram of an intersection incorporating an object detection system, according to embodiments of the present invention;

FIG. 4 is a flow chart of the method of object mapping for the vehicle-traffic system, according to embodiments of the present invention; and

FIG. 5 is a schematic view of an example computing device executing any system or methods described herein.

Like reference symbols in the various drawings indicate like elements.

### DETAILED DESCRIPTION OF THE PREFERRED EMBODIMENTS

The following description of the preferred embodiment(s) is merely exemplary in nature and is in no way intended to limit the invention, its application, or uses.

Autonomous and semi-autonomous driving has been gaining interest in the past few years. To increase transportation safety of autonomous and semi-autonomous vehicles, it is important to have an accurate idea of the infrastructure (i.e., roads, lanes, traffic signs, crosswalks, sidewalks, light posts, buildings, etc.) that is being used by these vehicles, and know the active participants (e.g., vehicles, pedestrians, etc.) using the infrastructure. A vehicle-traffic system as described below may be used by the autonomous and semi-autonomous vehicles to map objecting in an environment and improve driving accuracy and thus transportation safety.

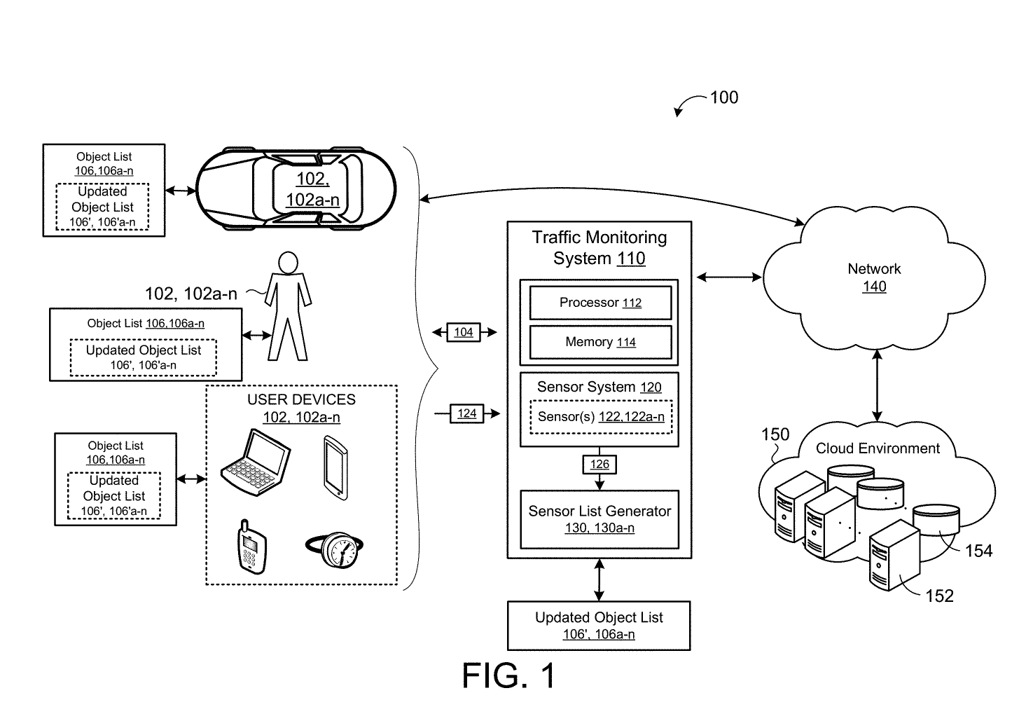

Referring to FIGS. 1-3, an intersection, shown generally at 10, incorporating an example of a vehicle-traffic system 100 for object detection and mapping an environment is shown. Located at the intersection is a plurality of vehicles 102a-n (102a-i shown), which are travelling in various directions and speeds.

The vehicle-traffic system 100 includes an infrastructure system 110 that includes a computing device (or hardware processor) 112 (e.g., central processing unit having one or more computing processors) in communication with non-transitory memory or hardware memory 114 (e.g., a hard disk, flash memory, random-access memory) capable of storing instructions executable on the computing processor(s) 112. The infrastructure system 110 includes a sensor system 120. The sensor system 120 includes one or more sensors 122a-n positioned at one or more parking areas 10 and configured to sense one or more traffic participants 102, 102a-c. Traffic participants 102, 102a-n may include, but are not limited to, vehicles, pedestrians and bicyclists, and user devices. In some implementations, the user device is any computing device capable of communicating with the sensors 122. The user device may include, but is not limited to, a mobile computing device, such as a laptop, a tablet, a smart phone, and a wearable computing device (e.g., headsets and/or watches). The user device may also include other computing devices having other form factors, such as a gaming device.

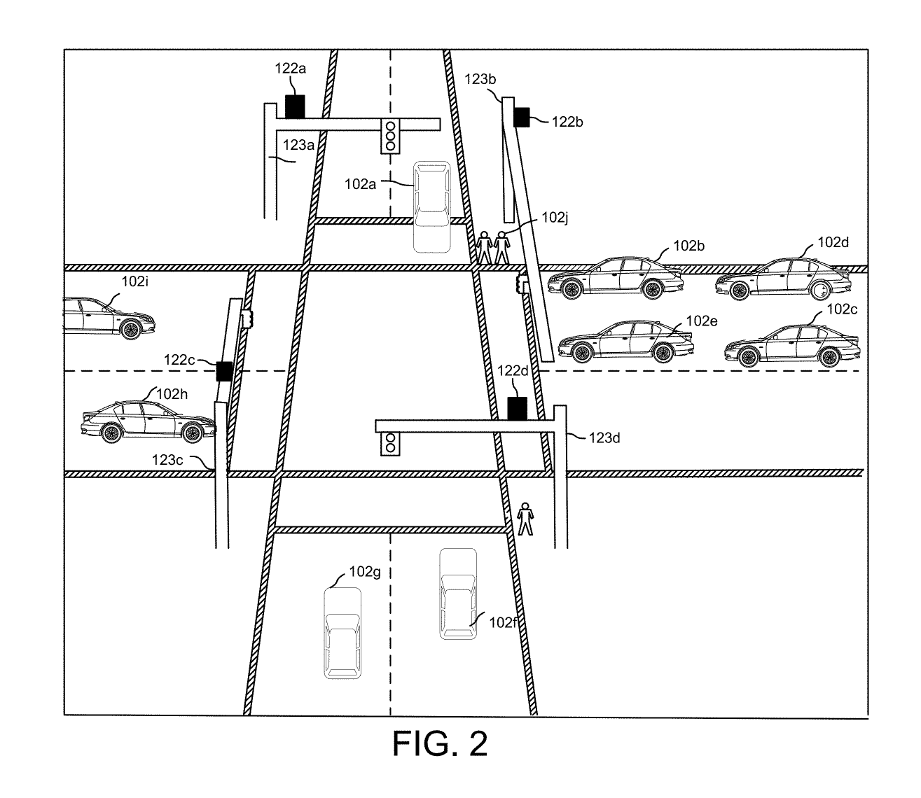

In some implementations, the one or more sensors 122a-n may be positioned to capture data 124 associated with a specific area 10, where each sensor 122a-n captures data 124 associated with a portion of the area 10. As a result, the sensor data 124 associated with each sensor 122a-n includes sensor data 124 associated with the entire area 10. The intersection 10 includes various infrastructure components, which in this embodiment are shown as posts 123a-n in FIG. 2, where at least one sensor and at least one communication device is connected to each of the posts 123a-n. While in this embodiment, each infrastructure component is shown as a post 123a-n, it is within the scope of the invention that the object detection system may include any other type of infrastructure component, such as a building, bridge, parking structure, support structure, or the like. There are three sensors in this embodiment, and each sensor is able to detect objects in a detection area, shown generally at 16a,16b,16c.

The sensors 120 may include, but are not limited to, Radar, Sonar, LIDAR (Light Detection and Ranging, which can entail optical remote sensing that measures properties of scattered light to find range and/or other information of a distant target), HFL (High Flash LIDAR), LADAR (Laser Detection and Ranging), cameras (e.g., monocular camera, binocular camera).

Each sensor 120 is positioned at a location where the sensor 120 can capture sensor data 124 associated with the traffic participants 102, 102a-n at the specific location. Therefore, the sensor system 120 analyses the sensor data 124 captured by the one or more sensors 122a-n. The analysis of the sensor data 124 includes the sensor system 120 identifying one or more traffic participants 102 and determining a sensor list 130.

Additionally, each vehicle 102a-n may also include at least one sensor, and in one embodiment, each vehicle 102a-n includes a plurality of sensors and at least one communication device, as well as a GPS system. Each of the (equipped) vehicles 102, 102a-n provides their own object list 106, 106a-n. Both the sensor list 130 and the object list 106, 106a-n include a plurality of attributes associated with each traffic participant 102. The object list 106, 106a-n attributes may include, but are not limited to, the location of the traffic participant 102 (e.g., in a coordinate system), a speed associated with the traffic participant 102, a heading of the traffic participant, a unique ID, a color, a number, a type of the traffic participant 102, 102a-n (e.g., vehicles, pedestrians and bicyclists, user devices), and other attributes of each traffic participant 102, 102a-n within the area 10.

Similarly, the sensor list 130, 130a-n also includes the location of each traffic participant 102 (e.g., in a coordinate system), a speed associated with that traffic participant 102, a heading of that traffic participant, a unique ID, a color, a number, a type of the traffic participant 102, 102a-n (e.g., vehicles, pedestrians and bicyclists, user devices), and other attributes of each traffic participant 102, 102a-n within the area 10.

Each sensor that is mounted on the infrastructure 123a-n and the sensors on the vehicles 102a-n are able to detect the location, as well as speed and direction of each vehicle 102a-n, and the location, speed, and direction of any pedestrian that is located in proximity to the intersection 10. In one example, the pedestrians may be walking, but it is within the scope of the invention that the sensors are able to detect if the pedestrians are walking, traveling by bicycle, scooter, skateboard, rollerblades, or the like.

In addition to the sensors, each vehicle 102a-n is also equipped with an identifier. The identifier may be one or a combination of identifiers specific to a particular vehicle and/or traffic participant. Each vehicle 102a-n may have the roof painted a specific color different from every other vehicle, a specific number, a bar code, or a Quick Response (QR) code. For example, in closed traffic system locations such as golf courses, automated community shuttles, parking lot shuttle services, etc. The identifiers may be included in the object list 106, 106a-n provided by each vehicle 102, 12a-n and may also visible in a manner that can be detected by the sensors 122, 122a-n, such that the same identifiers can be included on the sensor list 130, 130a-n.

In one embodiment, the communication device connected to each post 123a-n and used in each vehicle 102a-n is a dedicated short range communication (DSRC) device, but it is within the scope of the invention that other types of communication devices maybe used, for example but not limited to, 3G, LTE, 5G, WiFi, Bluetooth.

The sensors list 130, 130a-n and the object list 106, 106a-n are compared with one another, by matching each of the vehicles 102, 102a-n on the sensors list 130, 130a-n and the object list 106, 106a-n using the unique ID, color and number. Once the attributes for each vehicle 102, 102a-n have been matched they are compared within one another, i.e. object list location, speed, heading, etc 106, 1-6a-n are compared with sensor list location, speed, heading, etc 130, 130a-n. Additionally, the vehicles 102, 102a-n and attributes on the object list 106, 106a-n are combined with the sensor list 130, 130a-n. The combined data is used to generate an updated object list 106′, 106′a-n which includes both map data and attributes for each vehicle 102, 102a-n.

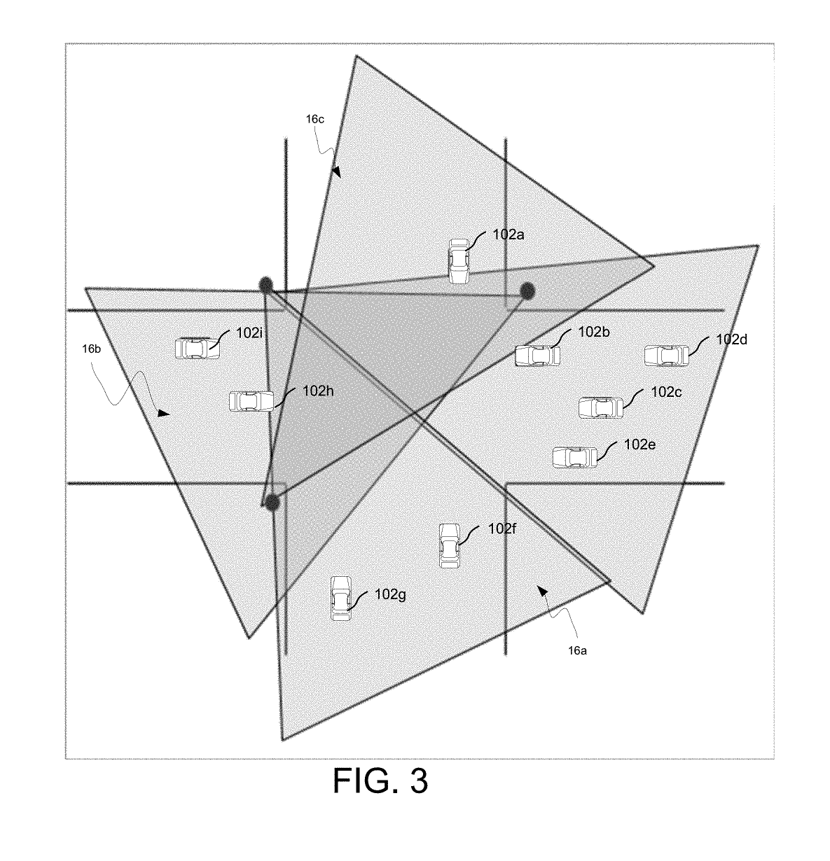

The sensor list 130, 130a-n may include traffic participants 102, 102a-n that are not on the object list 106, 106a-n from a particular traffic participant 102, 102a-n. For example, referring to FIGS. 2-3 vehicles 102i and vehicles 102e may not be able to sense vehicle 102g. Vehicle 102g may therefore, not be on the object list 106e, 106i from those vehicles 102e, 102g but may be included on the sensor list 130, 130a-n as well as on the object list 160, 106a-n from other traffic participants 102, 102a-n. Likewise, traffic participant(s) 102j are pedestrians, which may have a smart device to provide a object list 12j or may not. Additionally, traffic participants 102j may be obstructed from view by various other traffic participants, e.g. 102c. In this case the sensor list 130, 130a-n and the object list 106, 106a-n from other traffic participants may provide the identifier and attribute information.

Further, the sensor list 130, 130a-n may be generated from sensors that are more accurate then what is available to the traffic participants 102, 102a-n to generate the object list 106, 106a-n. Therefore, the position, speed, heading, etc for each traffic participant may have more accurate and precise information from the sensor list 130, 130a-n. This information can also be integrated into the updated object list 106′, 16′a-n.

The updated object list 106′, 106′a-n will include all traffic participants 102, 102a-n that have been sensed from the traffic participants 102, 102a-n and included on the object list 106, 106a-n as well as all traffic participants 102, 102a-n that have been sensed by the sensors 122, 122a-n and included on the sensor list 130, 130a-n.

While traffic participants 102, 102a-n which are vehicles may be part of a system (e.g. golf courses, community shuttles, parking lot shuttles, amusement part transportation, etc.) and have a dedicated unique ID, identifier, color and number other traffic participants 102, 102a-n (such as pedestrians, cyclists, etc.) may be assigned temporary unique ID, identifier, color and number information while they are in range of the traffic monitoring system 100.

The updated object list 106′, 106′a-n can be sent to all traffic participants 12, 102a-n and the updated, more accurate information can be used. For example, when the traffic participant 102, 102a-n is a vehicle the more accurate position information can be used to update the accuracy of onboard vehicles systems, GPS location, vehicle dynamics, autonomous steering and braking, etc. Further, when the traffic participant is a pedestrian and/or cyclists if they have a smart device their position information can also be updated, e.g. more accurate walking directions, travelling distances, updating tracking device information, etc.

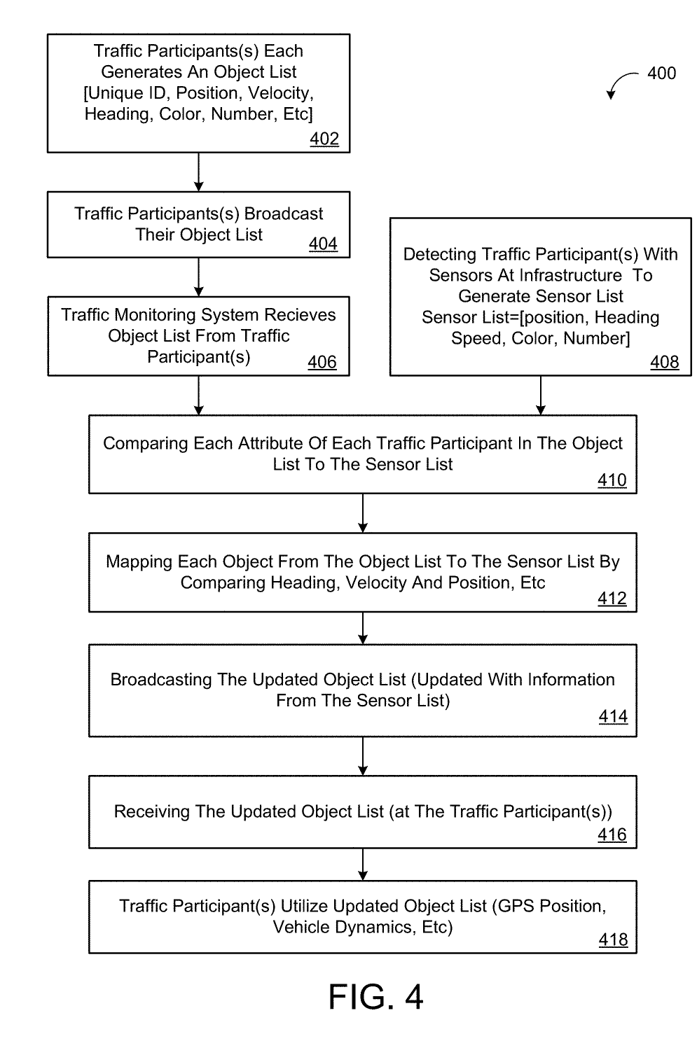

A flow chart depicting the steps of using the traffic monitoring and object detection system 110 of the present invention is shown in FIG. 4 generally at 400. Each traffic participant 102, 102a-n generates their own object list 106, 106a-n which may include a unique ID, position, velocity, heading, color number, etc), shown at block 402.

The object detection and traffic monitoring system includes traffic participant 102a-n each using a communication device, e.g. a corresponding DSRC device to broadcasting the object list 106, 106a-n to the system 110, shown at block 404. The broadcast list is received by the traffic monitoring system 110, shown at block 406.

Local infrastructure 123a-n, such as the posts, each have at least one sensor 122, 122a-n which gather date. The sensors at each infrastructure location 123a-n detect the location and direction of any traffic participant(s) 102a-n, especially vehicles, as well as any pedestrians or other moving objects located in the detection areas 16a-n. The data is used to generate a sensor list 130, 130a-n, shown at block 408.

Additionally, the sensor list 130, 130a-n and the object list(s) 106, 106a-n are compared to one another, shown at 410. Each object from both the object list and sensor list are mapped by comparing location, velocity, and direction information, shown at 412. The object list is then updated as necessary using any additional position information from the sensor list, shown at 412. The updated object detection list 106′, 106′a-n is then broadcast by the traffic system 110, shown at block 414. Each traffic participant 102, 102a-n is then able to then receive the updated object list 106′, 106′a-n to have a more accurate location of any nearby traffic participant(s) 12, 102a-n, 416.

The traffic participants(s) 102a-n then utilize the updated object list 106′, 16′a-n information to update position and add to their own information, e.g. GPS position, and vehicle dynamics information, shown at 418. Although shown at part of method 400 for some embodiments receiving and utilizing the updated object list may not be considered part of the traffic monitoring system 110.

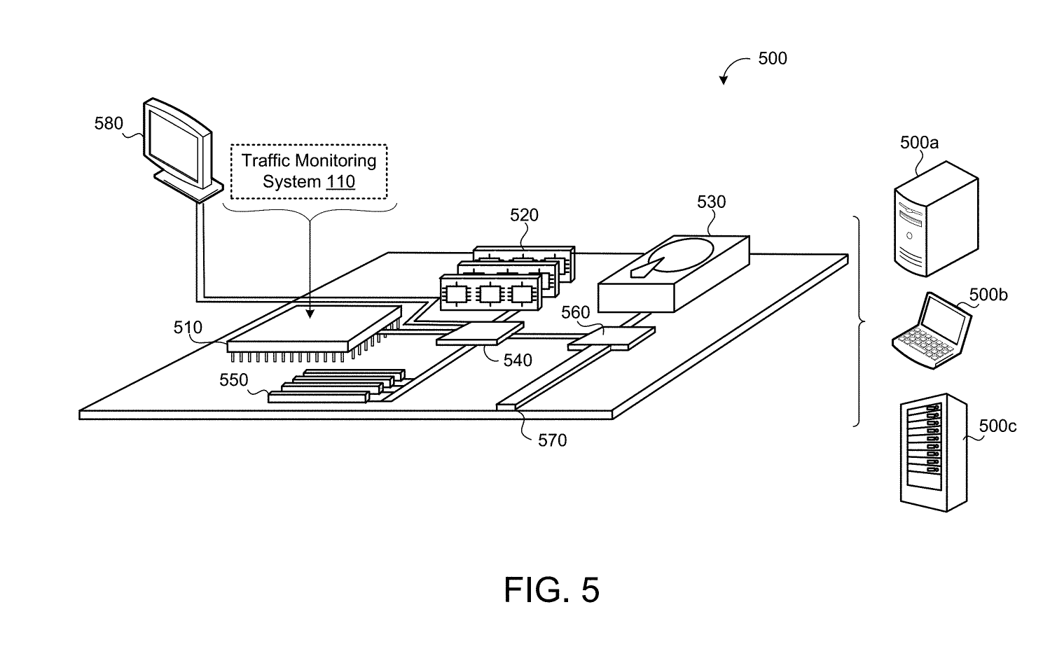

FIG. 5 is schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to low speed bus 570 and storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high-speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and low-speed expansion port 570. The low-speed expansion port 570, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A traffic monitoring system comprising:
receiving, at a hardware processor, sensor data from one or more sensors in communication with the hardware processor and positioned such that the surface area is within a field of view of the one or more sensors;
identifying, at the hardware processor, one or more traffic participants from the sensor data;
determining, at the hardware processor, one or more attributes associated with each one of the one or more traffic participants;
generating a sensor list of the one or more traffic participants, wherein the sensor list includes identifiers and attributes associated with each of the one or more traffic participants;
receiving at the hardware process, an object list from the one or more traffic participants, wherein the object list includes identifiers and attributes for the associated one or more traffic participants;
comparing the sensor list with the object list;
generating a map from the comparison of the sensor list with the object list;
generating an updated object list from the comparison and the map; and
broadcasting the updated object list.

2. The method of claim 1, further comprising:
receiving at the one or more traffic participants the updated object list; and
updating at least one information system of the one or more traffic participants to use the updated object list information.

3. The method of claim 1, further comprising assigning identifiers and attributes on the sensor list to the one or more traffic participants based on the sensed information from each of the one or more traffic participants.

4. The method of claim 3, wherein comparing the sensor list with the object list further comprises matching the identifiers on the sensor list with the identifiers on the objects list

5. The method of claim 2, wherein the identifiers and attributes on the sensor list include one or more of: a unique ID, a location of the one or more traffic participant, a velocity of the one or more the traffic participants, and a direction of of the one or more the traffic participants, a color associated with the one or more the traffic participants, a number associated with the one or more the traffic participants, and a category associated with the one or more the traffic participants.

6. The method of claim 2, wherein each of the plurality of identifiers further comprising one selected from the group consisting of a painted roof, a reference number, a bar code, and a Quick Response (QR) code.

7. The method of claim 1, wherein the identifiers and attributes on the object list include one or more of: a unique ID, a location of the one or more traffic participant, a velocity of the one or more the traffic participants, and a direction of of the one or more the traffic participants, a color associated with the one or more the traffic participants, a number associated with the one or more the traffic participants, and a category associated with the one or more the traffic participants.

8. The method of claim 7, wherein each of the plurality of identifiers further comprising one selected from the group consisting of a painted roof, a reference number, a bar code, and a Quick Response (QR) code.

9. The method of claim 1, wherein the at least one sensor being one selected from the group consisting of long-range radar, short-range radar, LIDAR (Light Imaging, Detection, and Ranging), LADAR (Laser Imaging, Detection, and Ranging), camera, ultrasound, and sonar.

10. A traffic monitoring system comprising:
a plurality of sensors connected to at least one infrastructure component, wherein the plurality of sensors are each operable for detecting one or more objects in a detection area, where a sensor list is generated for each of the objects;
at least one communication device associated with the at least one infrastructure component;
a hardware processor operable to receive a communication from the at least one communication device and each of a plurality of traffic participants, wherein each communication from the plurality of traffic participants includes an object list; and
a hardware memory in communication with the hardware processor, the hardware memory storing instructions that when executed on the hardware processor cause the hardware processor to perform operations comprising:
comparing the sensor list with the object list;
generating a map from the comparison of the sensor list with the object list;
generating an updated object list from the comparison and the map; and
broadcasting the updated object list.

11. The apparatus of claim 10, wherein the operations further include:
receiving at the one or more traffic participants the updated object list; and
updating at least one information system of the one or more traffic participants to use the updated object list information.

12. The apparatus of claim 10, wherein identifiers and attributes on the sensor list are assigned to the one or more traffic participants based on the sensed information from each of the one or more traffic participants.

13. The apparatus of claim 12, wherein comparing the sensor list with the object list further comprises matching the identifiers on the sensor list with the identifiers on the objects list

14. The apparatus of claim 11, wherein the identifiers and attributes on the sensor list include one or more of: a unique ID, a location of the one or more traffic participant, a velocity of the one or more the traffic participants, and a direction of of the one or more the traffic participants, a color associated with the one or more the traffic participants, a number associated with the one or more the traffic participants, and a category associated with the one or more the traffic participants.

15. The apparatus of claim 11, wherein each of the plurality of identifiers further comprising one selected from the group consisting of a painted roof, a reference number, a bar code, and a Quick Response (QR) code.

16. The apparatus of claim 10, wherein the identifiers and attributes on the object list include one or more of: a unique ID, a location of the one or more traffic participant, a velocity of the one or more the traffic participants, and a direction of the one or more the traffic participants, a color associated with the one or more the traffic participants, a number associated with the one or more the traffic participants, and a category associated with the one or more the traffic participants.

17. The apparatus of claim 16, wherein each of the plurality of identifiers further comprising one selected from the group consisting of a painted roof, a reference number, a bar code, and a Quick Response (QR) code.

18. The apparatus of claim 10, wherein the at least one sensor being one selected from the group consisting of long-range radar, short-range radar, LIDAR (Light Imaging, Detection, and Ranging), LADAR (Laser Imaging, Detection, and Ranging), camera, ultrasound, and sonar.
